(19) United States
(12) Patent Application Publication
(10) Pub. No.: US 2006/0083462 A1
(43) Pub. Date: Apr. 20, 2006

(54) Artificial cladding grating in integrated optics comprising a coupling variation and production method thereof

(75) Inventor: Christophe Martinez, Grenoble (FR)

Correspondence Address: PILLSBURY WINTHROP SHAW PITTMAN, LLP, P.O. BOX 10500, MCLEAN, VA, 22102, US

(73) Assignee: Teem Photonics, Meylan (FR)

(21) Appl. No.: 10/538,140

(22) PCT Filed: Dec. 15, 2003
(86) PCT No.: PCT/FR03/50169

§ 371 Date: Jun. 9, 2005

(30) Foreign Application Priority Data
Dec. 16, 2002 (FR) 02 15917

(51) Int. Cl. G02B 6/34

(52) U.S. Cl. 385/37; 385/28

(57) ABSTRACT

The invention relates to an integrated optics artificial cladding grating comprising in a substrate (20) an optical guide core (2), an optical cladding (3, 3a, 3b, 3c, 3d) independent of the core and surrounding at least a portion of the core in a zone of the substrate called the zone of interaction (I1) comprising a grating (19) capable of coupling at least one guided mode of the core to at least one cladding mode or vice versa, the said zone of interaction comprising a coupling variation along the direction of propagation z of the modes, the refractive index of the cladding being different to the refractive index of the substrate and lower than the refractive index of the core in at least the part of the cladding next to the core in the interaction zone.

### TECHNICAL FIELD

The invention relates to an integrated optics artificial cladding grating, with coupling variation and its creation process.

By artificial cladding grating (ACG) we mean a zone of interaction created in a substrate, this zone of interaction comprising a core created in the substrate, a cladding created artificially in the substrate independently of the core and a grating. The grating is capable of coupling the core mode(s) to one or more cladding modes and vice versa.

The invention has applications in all fields requiring in particular spectral filtering. It particularly applies to the manufacture of gain flatteners for optical amplifiers used for example in the telecommunications field or even for making linear response filters with a wavelength on a spectral band defined for spectral recognition, in particular for measuring spectral offsets from power variation for example in the field of sensors.

Generally, the invention is particularly well suited to all systems requiring the use of spectral response filtering adapted to a specific requirement, this type of filtering generally requiring the development of an advanced filter.

### STATE OF THE PRIOR ART

The use of optical grating is known in the field of optical fibres.

In this field, the optical cladding usually surrounds the fibre core and has a refractive index lower than that of the core to allow a light wave to spread in the core. Conjointly, the optical cladding permits the core to be held mechanically. The core of a fibre cannot exist without the cladding.

Furthermore, the optical grating made in the fibre permits one or more guided modes in the core of a fibre to be coupled to the fibre cladding mode(s) and vice versa. This grating is generally formed in the fibre core.

To vary the coupling of this type of grating, it is known that the size of the cladding can be modified in order to modify the effective index of the guided mode(s).

We can refer for example to the patent U.S. Pat. No. 5,420,948.

However, making cladding of variable is complex. In particular, it calls on laser exposure techniques, stretching of the fibre or chemical etching, thus making the final component fragile.

In FIG. 1, there is a cross sectional view of containing the direction z the light wave spreads in, such an optical fibre. This fibre is composed of a core 9 and cladding 11. The cladding has a first taper 11a in which a grating 13 is positioned. The narrowing of the cladding varies the effective index along the length of the grating, which creates a “chirp” on the grating, which is to say a variation of the resonance wavelength along the grating.

The cladding then has a narrower zone 11b that has a consistent sized cross section, then a wider zone 11c permitting the narrower section of the cladding to be adapted to its normal section.

Modulating the size of the cladding is obtained in this case by chemical attack or stretching fusion of the fibre.

In addition to the mechanical difficulties, the fibre core cannot exist without the optical cladding, this dependence limits the possibilities of changing the cladding parameters, gratings and solutions for design, architecture and integration of the gratings in complex systems.

### DESCRIPTION OF THE INVENTION

The purpose of this invention is to propose an integrated optics artificial cladding grating, with a coupling variation and its creation process. The use of cladding according to the invention permitting the difficulties of the prior art to be overcome by offering on the one hand more possibilities in making this variation and on the other hand a structure that is not fragile.

One purpose of the invention is to propose an artificial cladding grating, the optical cladding being independent from the guide core to which it is associated. By independence of the core and the cladding, we mean that they can exist in a substrate independently from one another. In other words, the core can exist without the cladding and the cladding can exist without the core.

More precisely, integrated optics the artificial cladding grating of the invention comprises in a substrate an optical guide core, an optical cladding independent of the core and surrounding at least a portion of the core in a zone of the substrate called the zone of interaction, comprising a grating capable of coupling at least one guided mode of the core to at least one cladding mode or vice versa, the said zone of interaction comprising a coupling variation along the propagation direction of the modes, the refractive index of the cladding being different from the refractive index of the substrate and lower than the refractive index of the core in at least part of the cladding next to the core in the interaction zone.

By surrounding, it is meant that the fundamental mode profile of the core guide has a maximum that is included in the index profile of the cladding. Thus, the profile of the fundamental mode of the core may be completely or partially included in the index profile of the cladding, which at structural level leads to a core situated anywhere at all in the cladding including at its periphery, in which case the core may be partially outside of the cladding.

Coupling the modes generated by the grating has two main characteristics: the coupling wavelength and the coupling force. Advantageously, it is these characteristics for which the variations are made.

Thus, according to the invention, the coupling variation along the propagation direction of the modes may be a variation of the coupling force and/or of the coupling wavelength. This variation is such that it permits desired luminous spectra to be obtained at the output of the zone of interaction in the cladding and/or in the core.

This coupling variation thus permits the use of the artificial cladding grating of the invention in a large number of components, taking into account that the coupling may thus be adapted to the desired application.

Different embodiments of this variation, which may be combined with one another, may be envisaged.

According to a first embodiment, the coupling variation of the artificial cladding grating is obtained by modulation of the section of the cladding in the interaction zone.

According to a second embodiment, the coupling variation of the artificial cladding grating is obtained by variation of the centring of the core with respect to the section of the cladding. In fact, it is possible to change the relative position of the core with respect to the cladding or the cladding with respect to the core.

The coupling by a grating between different modes takes place for determined wavelengths λⱼ defined by the following known relation:
λⱼ=Λ×(n₀-nⱼ) (1)
where:

n₀ is the effective index of the guided mode 0 in the core,

nⱼ is the effective index of the cladding mode number j,

λⱼ is the resonance wavelength for the coupling in mode j,

Λ is the grating period.

This coupling is translated by an energy transfer between the guided mode of the core and the cladding mode(s) for the central wavelength λⱼ or vice versa. The energy coupled in the cladding modes is then guided in the cladding, the same logic may be applied for the coupled mode in the core.

The modification of λⱼ therefore passes via setting the parameters of Λ and/or the distribution of the effective indices of the different modes.

Furthermore, the efficiency of the coupling between the modes depends on the length of the grating and the coupling coefficient K_{0J} between the modes 0 and j. This coefficient is given by the spatial recovery integral of the modes 0 and j, weighted by the index profile induced by the grating. We therefore have a relationship of the type:

$${K}_{0 J} ∝ \int \int {ξ}_{0} \cdot {ξ}_{J}^{*} \cdot ΔΔ n . s \qquad ( 2 )$$

where:

ξ₀ and ξⱼ are the transversal profiles of the modes 0 and j and ξ*ⱼ the complex conjugate of ξⱼ,

Δn is the amplitude of the effective index modulation induced by the grating in a plane perpendicular to the direction of propagation of the modes,

ds is an integration element in a plane perpendicular to the direction of propagation of the modes.

The modification of K_{0J} is obtained by varying the profile of the modes and/or the index profile induced by the grating, in other words by varying in particular the opto-geometrical characteristics of the cladding.

As concerns the cladding, the larger its dimensions and index level, the more cladding modes will be accepted for propagation and the more filtering spectral bands will be possible. This may be an advantage if searching for multiple filtering or to have more leeway when choosing a filtering mode.

If searching to limit the number of cladding modes that can be coupled, it is on the contrary useful to reduce the opto-geometrical dimensions of the cladding.

At core level, its dimensions and index level condition the characteristics of the mode propagating. Furthermore, the larger the index differences between the core, the cladding and the substrate, the higher the chance of potentially having couplings for low grating periods as shown by the equation (1) (at a given resonance wavelength, the period is inversely related to the index difference between the guided mode of the core and the cladding mode).

By modifying the position of the core, the grating and the cladding, it is possible to generate different couplings. In fact, we can clearly see from the equation (2) that the coupling force depends on the relative position in the plane transversal to the direction of propagation of the profiles of the cladding mode, of the guided mode in the core and the grating.

As the parameters related to the grating are more difficult to control than those related to the cladding, we choose to create advantageously a grating with a consistent pattern of period and/or amplitude and modify the other coupling parameters such as the opto-geometrical dimensions of the cladding and the core decentration.

In fact, as concerns the decentration of the core, if the core mode and the cladding mode as well as Δn have symmetrical profiles, the coupling coefficient is generally not zero. In this case, it can be shown that a decentration of the core with respect to the cladding only slightly changes the value of K.

If on the other hand we consider a coupling with a symmetrical fundamental mode with a non-symmetrical fundamental mode, the recovery integral is nil. In this case, the presence of a decentration between the core and the guide increases K. It is then shown that this variation of K depends on the decentration δx but only slightly on the variation of the size of the cladding.

Moreover, creating the integrated optics artificial cladding grating enables the cladding to be obtained advantageously by modification of the refractive index of the substrate, in particular by implantation or ionic exchange. Consequently, the desired form of the cladding may be obtained without etching or stretching as in the prior art, but for example with a mask with a suitable pattern.

The solution of the invention thus offers practical creating advantages (in particular simplicity and strength).

Furthermore, the cladding and the core exist independently from one another in the substrate, which is not the case in the prior art. This independence makes possible more flexibility when creating the component of the invention and easier integration of this component in a complex architecture. In particular, the core may no longer be situated in the cladding outside of the zones of interaction but solely in the substrate, which permits the optical isolation of the core. In this way, the cladding only acts on the propagation of a light wave in the associated guide core in the part surrounding the core and the cladding can guide or transport light waves independently of the core. This independence between the core and the cladding also permits a greater number of combinations to be created by varying not only the size of the cladding but also the position of the core in the cladding.

The grating of the invention, formed in the interaction zone, may comprise one or more elementary gratings. By elementary grating we mean a grating of which all the structural parameters are constant.

The grating may be made by direct disturbance of the guide core for example, by segmentation of the core and/or by variation of the core section. The grating may also be obtained by indirect disturbance of the core, such as surface etching of the substrate, segmentation of the cladding and/or variation of the cladding section. These different embodiments may be combined with one another.

Consequently, apodised or chirped type gratings may thus be made.

The substrate may of course be made from a single material or by superposition of several layers of materials. In the latter case, the refractive index of the cladding is different to the refractive index of the substrate at least as concerns the neighbouring layers of the cladding.

Advantageously, the cladding has a refractive index higher than that of the substrate.

According to the invention, the guide may be a planar guide, when the confinement of the light takes place in a plane comprising the direction of propagation of the light or a microguide, when the confinement of the light takes place in two directions transversal to the direction of propagation of the light.

According to the invention, a light wave introduced in the core of an artificial cladding grating is filtered in the said zone. In fact, one or more guided modes of the light wave introduced in the core are coupled in the zone of interaction, by the grating, to one or more cladding modes associated to this zone, for wave lengths λⱼ defined in the relationship (1). The coupled part of the light wave in the one or more cladding modes may be recovered or not when it leaves the cladding and the non-coupled part of the wave continues to be transported by the core at the output of the interaction zone. The said core may be connected to an optical component. The same logic may be applied when the light wave is introduced in the cladding.

The artificial cladding grating of the invention applies in particular to the manufacture of a gain flattener. In this case, the coupling variation must be such that a light wave comprising several spectral bands of different amplitudes, after passing through the said zone of interaction is transformed into a light wave whose spectral bands all have more or less the same amplitude.

By spectral band, it is meant a band with a set of wavelengths with a determined central wavelength and bandwidth, a light wave being able to comprise one or more spectral bands.

The use of such a component is of particular interest in an optical amplifier, in order to recover at the amplifier output a light wave whose spectral bands all have the same amplitude.

The artificial cladding grating of the invention also applies in particular to the manufacture of a linear filter. In fact, a linear filter is a filtering component whose spectral transfer function is linear with respect to the wavelength. The use of such a component permits for example to stabilise the frequency of a laser source. In particular, the passage of a laser signal with a narrow spectral band around a central wavelength λ₀ by a suitable filter made according to the invention provides in output a signal proportional to this wavelength T(λ0)=aλ₀+β where β is a constant. The slightest spectral offset in either direction of the spectrum then creates a drop or an increase in the output signal. We can therefore create a servo control for this output signal to a laser control acting on the spectral position of the emission and thus stabilise the source. The stabilisation of the laser source therefore only requires an artificial cladding grating and a photo-detector, a spectrum analyser is no longer of use.

According to one preferred embodiment, the cladding and/or the guide core and/or the grating may be made by all types of technique permitting the refractive index of the substrate to be modified. We can mention in particular the ion exchanges techniques, ionic implantation and/or radiation for example by laser exposure or laser photo inscription (the radiation produces local heating) or even depositing of layers.

The ion exchange technology in glass is of particular interest but other substrates than glass may of course be used such as for example crystalline substrates of the KTP or LiNbO₃ types, or even LiTaO₃.

More generally, the grating may be made using any techniques permitting the effective index of the substrate to be changed. In addition to the techniques already mentioned, we can therefore add in particular the techniques for making gratings by etching the substrate. This etching may be carried out above the cladding or in the portion of cladding of the zone of interaction and/or in the core portion of the interaction zone.

The grating pattern may be obtained either by laser sweeping in the case of radiation being used, or by a mask. The latter may be the mask, which permits the core and/or the cladding to be obtained, or a specific mask to make the grating.

The invention also relates to a process for making an artificial cladding grating as previously defined, the cladding, the guide core and the grating being made respectively by modification of the refractive index of the substrate so that at least in this part of the cladding next to the core and at least in the interaction zone, the refractive index of the cladding is different from the refractive index of the substrate and lower than the refractive index of the core, so that this zone of interaction has a coupling variation along the direction of propagation of the modes.

According to one preferred embodiment, the process of the invention comprises the following steps:

a) introduction of a first ionic species in the substrate so as to permit the optical cladding to be obtained after step c),

b) introduction of a second ionic species in the substrate so as to permit the guide core to be obtained after step c),

c) burying of the ions introduced in steps a) and b) so as to obtain the cladding and the guide core,

d) making the grating.

The order of the steps may of course be inverted.

The introduction of the first and/or second ionic species is performed advantageously by an ionic exchange, or by ionic implantation.

The first and the second ionic species may be the same or different.

The introduction of the first ionic species and/or the introduction of the second ionic species may be performed with the application of an electrical field.

In the case of an ionic exchange the substrate must contain ionic species capable of being exchanged.

According to one preferred embodiment, the substrate is glass and contains Na⁺ ions introduced beforehand, the first and the second ionic species are Ag⁺ and/or K⁺ ions.

According to one embodiment, step a) comprises the creation of a first mask comprising a pattern capable of obtaining the cladding, the first ionic species being introduced through this first mask and step b) comprises the elimination of the first mask and the creation of a second mask comprising a pattern capable of obtaining the core, the second ionic species being introduced though this second mask.

The masks used in the invention are for example made of aluminium, chrome, alumina or a dielectric material.

According to a first embodiment of step c), the first ionic species is buried at least partially prior to step b) and the second ionic species is buried at least partially after step b).

According to a second embodiment of step c), the first ionic species and the second ionic species are buried at the same time after step b).

According to a third embodiment of step c), the burying comprises a deposit of at least one layer of refractive index material advantageously lower than that of the cladding, on the surface of the substrate.

This mode may of course be combined with the two previous modes.

Advantageously, at least part of the burying is carried out with the application of an electrical field.

Generally before burying under the filed and/or the depositing of a layer, the process of the invention may moreover comprise burying by re-diffusion in an ionic bath.

This re-diffusion step may be partially carried out before step b) to re-diffuser the ions of the first ionic species and partially after step b) to re-diffuse the ions of the first and second ionic species. This re-diffusion step may also be carried out completely after step b) to re-diffuse the ions of the first and second ionic species.

By way of example this re-diffusion is obtained by plunging the substrate in a bath containing the same ionic species as that contained beforehand in the substrate.

Step d) for creating the grating may be carried out independently of steps a) and b) or be carried out simultaneously during step a) and/or step b).

Other characteristics and advantages of the invention will become clearer from the following description, with reference to the figures of the appended drawings. This description is provided by way of illustration and is in no way restrictive.

### BRIEF DESCRIPTION OF THE FIGURES

FIG. 1 already described, diagrammatically shows a grating made in an optical fibre, the optical cladding comprising a variation in section,

FIG. 2 diagrammatically shows a cross section of a first example of an artificial cladding grating according to the invention in which the section of the cladding varies discontinuously as well as the centring of the core in the cladding,

FIG. 3 diagrammatically shows in cross section a second example of artificial cladding grating according to the invention, in which only the section of the cladding varies and continuously,

FIG. 4 diagrammatically shows in cross section a third example of artificial cladding grating according to the invention, in which only the centring of the core in the cladding varies and continuously,

FIG. 5 diagrammatically shows in cross section, a fourth example of artificial cladding grating according to the invention, in which the section of the cladding as well as the centring of the core in the cladding vary continuously,

FIG. 6 diagrammatically shows in cross section, another example of artificial cladding grating according to the invention, in which also only the centring of the core in the cladding varies continuously,

FIGS. 7a to 7d diagrammatically shows in cross section an example of a manufacturing process for an artificial cladding grating according to the invention,

FIGS. 8a to 8d diagrammatically shows variants of embodiments of the mask pattern permitting a grating to be made, and

FIG. 9 shows in cross section a variant of an embodiment of an artificial cladding grating according to the invention with a grating in the cladding.

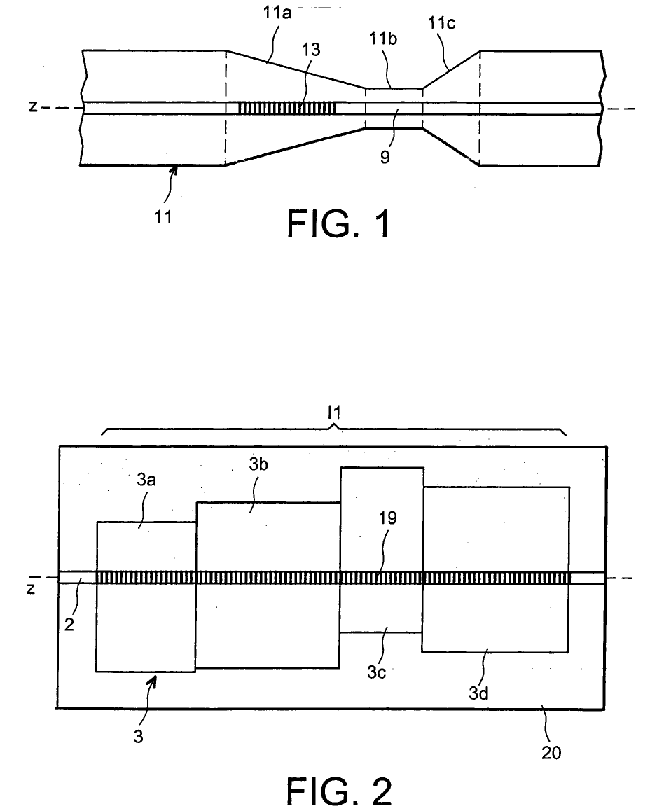

### DETAILED DESCRIPTION OF EMBODIMENTS OF THE INVENTION

FIG. 2 diagrammatically shows in cross section a first example of artificial cladding grating according to the invention in which the section of the cladding varies as well as the centring of the core in the cladding.

This cross section is made in a plane parallel to the surface of the substrate and containing the direction z of the propagation of the light wave in the core.

In this figure a substrate 20 is shown in which an optical cladding 3, a guide core 2 and a grating 19 are made.

The optical cladding 3 is independent from the core and surrounds part of the core in a zone of the substrate called the zone of interaction I1 comprising the grating 19.

In this embodiment, the grating is formed in the core 2. Furthermore, the cladding is composed of 4 parts respectively referenced 3a, 3b, 3c, 3d called elementary claddings which are placed in series. These elementary claddings have different sizes and centre positions at the guide core.

In this way, by modifying the size of the elementary claddings and the decentration of the core with respect to these elementary claddings, it is possible to obtain an evolved type grating.

In this embodiment, the guide core 2 and the grating 19 are uniform along the length of the interaction zone, only the form of the cladding and its position with respect to the core change. This evolution is made between levels thanks to the differences between the elementary claddings and permits the coupling in the interaction zone to be varied.

This type of artificial cladding grating may be used for example to create filtering capable, in particular, of creating a gain flattener especially for optical amplifiers or a linear response filter.

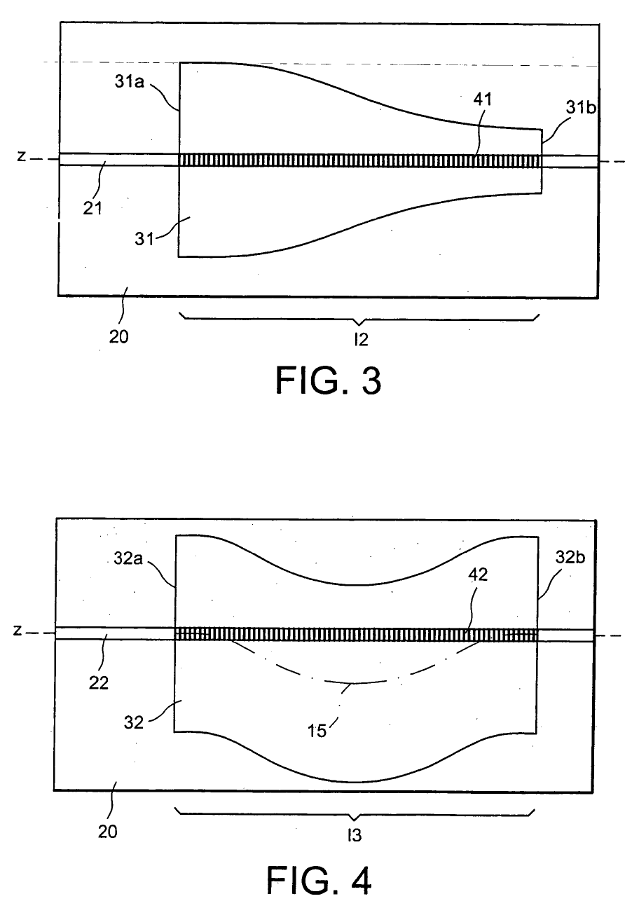

In general, the principle of placing in series elementary claddings surrounding a same guide core may be extended to the principle of a cladding whose position and/or size vary uniformly with respect to the core (and not by level as previously). FIGS. 3, 4 and 5 below are examples of this.

These figures are diagrammatical cross sections in a plane parallel to the surface of the substrate and containing the direction z of propagation of the light wave in the guide core.

FIG. 3 represents a cladding 31, a guide core 21 and a grating 41 in the substrate 20, formed in the core in this example.

The zone of interaction I2 corresponds to the zone of the substrate, which simultaneously comprises the cladding, the core and the grating.

The coupling variation along the direction z of propagation of a light wave in the core is obtained in this example by a variation of the section of the cladding in this direction. More precisely, the width of the cladding, considered in the plane of the figure, reduced by a maximum value at the end 31a of the cladding, to a minimum value at its other end 31b. This variation of the cladding width may be defined along the pattern of the grating according to a continuously variable function. Consequently, the coupling wavelength is also continuously variable (chirp effect) along the grating.

FIG. 4 shows an example of artificial cladding grating in which the variation of the coupling is obtained by decentration of the cladding with respect to the core, with the section of the cladding being constant. Therefore, in this figure, there is an optical cladding 32, a guide core 22 and a grating 42 in the substrate 20. The zone of interaction formed from these three 3 elements has the reference I3. The form of the cladding is such that its axis of symmetry 15 in the plane of the figure is decentred with respect to the centre of the cladding, with respect to the direction z, corresponding to the axis of symmetry of the core 22; the two ends 32a and 32b of the cladding on the other hand are progressively recentred in this direction z (in other words at the ends of the cladding, the axis 15 and the direction z are the same) so as to reduce the coupling coefficient.

In this way, the artificial cladding grating of the invention excites a non-symmetrical profile mode; it is an apodised type grating. In fact, this type of component is characterised by a grating whose coupling efficiency slightly decreases at its ends. Consequently, there is no discontinuous phenomenon in the coupling and the spectral response of the filter has much smaller secondary lobes than in the case of a standard grating.

The two previous examples may easily be extrapolated by those skilled in the art to create an artificial cladding grating that is both apodised and chirped.

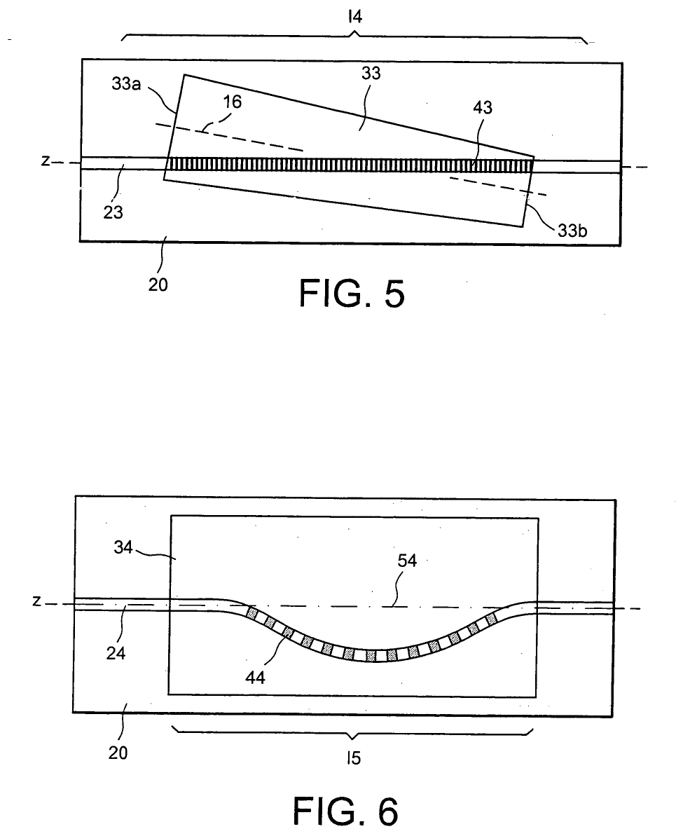

FIG. 5 shows an example of an artificial cladding grating according to the invention, whose coupling variation is obtained by a variation both of the size and of the position of the cladding with respect to the core, along of the grating.

The substrate 20 comprises a guide core 23, an artificial cladding 33 surrounding the core in a zone of interaction I4 and a grating 43 formed in the core 23 in the zone of interaction I4. In this zone, it can be seen that the cladding has a variable section, which tapers down from its end 33a towards its other end 33b. Furthermore, the axis of symmetry 16 of the cladding in the plane of the figure is not the same or parallel to the direction z of propagation in the core which is linear in the interaction zone. The axis 16 and the direction z are secants in the zone of interaction such that the cladding has a variable decentration in the said zone with respect to the core.

A coupling variation may also be obtained in the interaction zone by using a cladding of constant section and by varying the decentration of the core with respect to the cladding. FIG. 6 illustrates an example of an embodiment of this type.

This figure is a diagrammatical cross section in a plane that is parallel to the surface of the substrate that contains the direction z of propagation.

FIG. 6 shows the substrate 20 in which a cladding 34, a guide core 24 and a grating 44 are formed, that are part of the core in a zone of interaction I5 that is defined by a zone of the substrate in which the cladding surrounds the core. In this example, the axis of symmetry of the cladding in the plane of the figure is the same as the direction z de propagation whilst the axis of the core 54 is in this specific case the same as the direction z solely in the part which does not contain the grating. This axis 54 is different from the direction z in its part, which contains the grating.

In fact, the part of the core containing the grating turns away from the direction z then turns towards it until it again joins it, such that the guide core is decentred with respect to the cladding, this decentration leading to a coupling variation.

The various examples of artificial cladding grating embodiments described above may of course be combined with one another. Furthermore, in these various examples, the grating is part of the guide core but of course it can be part of the cladding and/or in the core or even in the substrate.

The component of the invention may of course be easily integrated into a more complex optical architecture such as that of an optical amplifier to create for example a gain flattener or a linear filter. The set of elements of these architectures may or may not be created on the same substrate as the component of the invention.

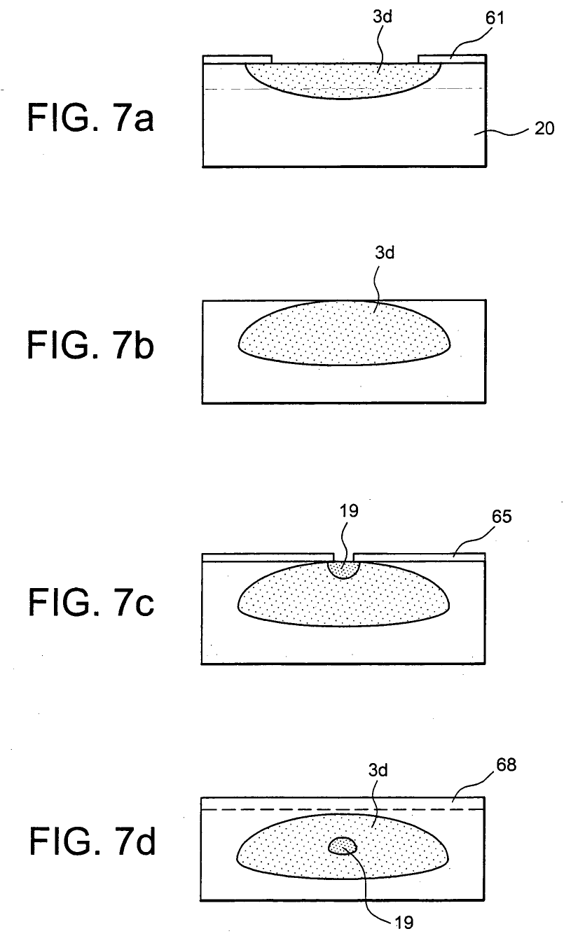

FIGS. 7a to 7d illustrate an example of an embodiment of an artificial cladding grating according to the invention, using the ion exchange technology.

These figures are cross sections in a plane perpendicular to the surface of the substrate and perpendicular to the direction z of propagation and contain an interaction zone, for example the zone of interaction I1 containing the elementary cladding 3d of FIG. 2.

In this way, FIG. 7a shows the substrate 20 containing ions B.

A first mask 61 is made for example by photolithography on some faces of the substrate; this mask comprises an opening that is determined according to the form and dimensions (width, length) of the cladding 3 that is to be produced.

A first ionic exchange is then carried out between the A ions and B ions contained in the substrate, in a zone of the substrate located close to the opening on the mask 61. This exchange is obtained for example by soaking the substrate fitted with the mask in a bath containing A ions and possibly by applying an electrical field between the face of the substrate on which the mask is placed and the opposite face. The zone of the substrate in which this ionic exchange takes place forms the cladding, which as we have previously seen may be non-uniform in terms of its dimensions, form and/or have variable centring.

To bury this cladding, a step for re-diffusing the A ions may be carried out with the use of an electrical field or not, applied as previously described. FIG. 7b shows the cladding after it has been partially buried. The mask 61 is generally removed prior to this step.

The creation of the cladding according to the invention is therefore similar to that of a guide core but with different dimensions.

The following step shown in FIG. 7c consists of forming a new mask 65 on the substrate for example by photolithography, after possible cleaning of the face of the substrate on which it is created. This mask comprises patterns capable of allowing a guide core 19 to be made and in particular when the core comprises a grating, the patterns of the mask 65 may be adapted to the patterns of the grating to be formed.

A second ionic exchange is then carried out between the B ions of the substrate and C ions which may or may not be the same as the A ions. This ionic exchange may be carried out as previously described by soaking the substrate in a bath containing C ions and by possibly applying an electrical field.

Finally, FIG. 7d shows the component obtained after the core 9 has been buried, by re-diffusing the C ions and final burying of the cladding, with or without the use of an electrical field. The mask 65 is generally removed prior to this burying step.

The conditions of the first and second ionic exchanges are defined so as to obtain the differences of refractive indices desired between the substrate, the cladding and the core. The adjustment parameters of these differences are in particular the exchange time, the temperature of the bath, the concentration of ions of the bath and the presence or absence of an electrical field.

By way of example of an embodiment, the substrate 20 is made of glass containing Na⁺ ions, and the mask 61 is made of aluminium.

The first ionic exchange is performed with a bath containing Ag⁺ ions at approximately 20% concentration, at a temperature of approximately 330° C. and for an exchange time of around 5 minutes. The ions are re-diffused first in open air at a temperature of approximately 330° C. for 30 s, then the cladding thus formed in the glass is partially buried. This burying is carried out by re-diffusion in a sodium bath at a temperature of approximately 260° C. The length of this step depends on the desired depth of burying for the final component. Consequently, for a surface component a length of approximately 3 minutes is sufficient, whereas for a buried component a duration of approximately 20 minutes will be chosen. In this second case, it is also necessary to bury under the field of the cladding before the second exchange. Therefore a current of 20 mA is applied between two sodium baths on either side of the plate at a temperature of 260° C. and for 10 minutes.

The mask 65 is also made of aluminium.

The second ionic exchange is performed with a bath also containing Ag⁺ ions at approximately 20% concentration, at a temperature of approximately 330° C. and for an exchange time of approximately 5 minutes, the ions are first re-diffused in free air at a temperature of approximately 330° C. and for 30 s. Then partial burying is carried out, of the core thus formed in the glass by re-diffusion in a sodium bath at a temperature of approximately 260° C. for 3 mn. For a buried component, this step is not necessary.

The final burying of the cladding and the core is carried out with the use of an electrical field, with the two opposite faces of the substrate in contact with two baths (in this example sodium) capable of allowing a potential difference to be applied between these two baths. For a surface component a duration of less than a minute is sufficient, in the case of a buried component a duration of around 30 minutes is used, the burying is carried out with a current of 20 mA at 240° C.

Many variants of the previously described process may be performed. In particular, the burying steps of the cladding and the core may be carried out as previously described during 2 successive steps, but they may also be carried out simultaneously in certain cases, the core having a higher ionic concentration than that of the cladding, it is buried more quickly than the cladding, which also permits possible centring of the core in the cladding.

The difference of concentration between the core and the cladding is generally obtained either by re-diffusing in a bath the ions forming the cladding or by a difference of concentration of the ions introduced in steps a) and b).

As we have previously seen, to bury the cladding and the core, a variant of the process consists of depositing on the substrate 20, a layer of material 68, shown in dotted lines on FIG. 7d. This material, in order to permit optical guidance, must advantageously have a refractive index lower than that of the cladding.

The creation of the component according to the invention is not limited to the ion exchange technique. The component of the invention may of course be made using any techniques, which permit the refractive index of the substrate to be modified.

Furthermore, as we have previously seen, the period, size and position of the grating created, with respect to the core and to the cladding, are parameters that can be adapted to suit the applications.

The pattern of the grating may be defined on the mask allowing the cladding to be made and/or on the mask allowing the core to be made or even on a specific mask for solely creating the grating.

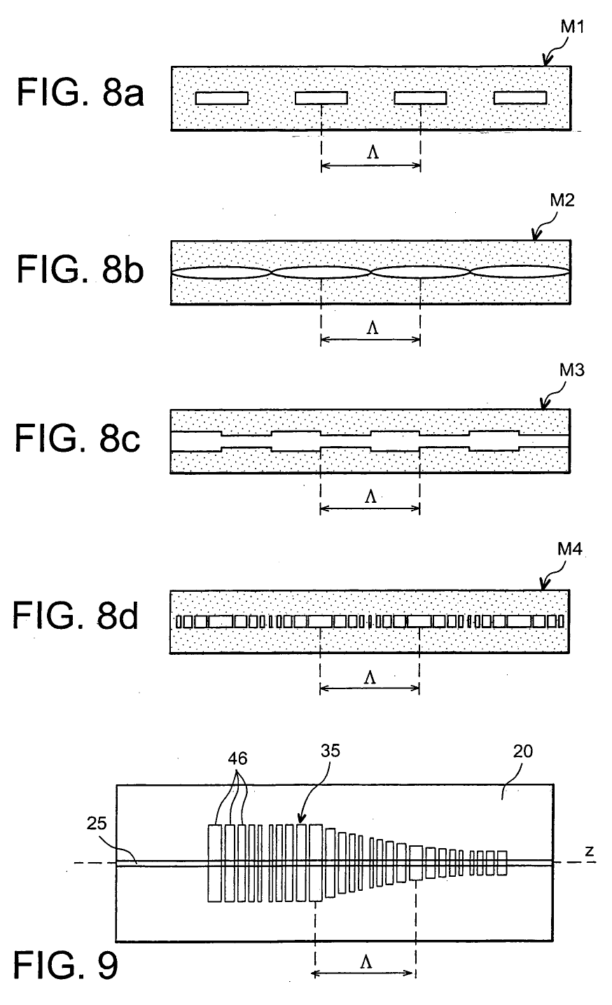

FIGS. 8a to 8d illustrate embodiments of masks M1, M2, M3, M4 permitting a grating to be obtained. These figures are elevation views of the masks and only represent the parts of the masks which allow the grating to be made. The white zones of the pattern of the masks correspond to the openings of the latter.

These masks permit a periodic grating of period A to be obtained. The masks M1 and M4 permit a grating to be obtained by segmentation whilst the masks M2 and M3 permit a grating to be obtained by variation of the width of the patterns.

These masks may be for example specific for creating the grating in the core and/or in the cladding or even in the substrate or part of the masks permitting the core and/or the cladding to be obtained, the grating then being created at the same time as the core and/or the cladding.

FIGS. 2 to 6 previously described show examples of gratings formed in the guide core.

FIG. 9 shows an example of an embodiment of an artificial cladding grating according to the invention whose grating is created by segmentation of the cladding 35.

In this way, the grating is formed in the cladding by alternating the period A of zones 46 with different refractive indices from that of the rest of the cladding. These zones 46 have a variable length, considered in the direction z of propagation of a light wave in the core 25. Furthermore, the width of the cladding considered in a direction perpendicular to the direction z is also variable to obtain a variable coupling. The core, as in the previous examples pass through the cladding, the grating being consequently also included in the core, in other words the core also comprises zones with different refractive indices from that of the rest of the core.

The gratings may be formed by any of the classic techniques permitting the effective index of the substrate in the core and/or in the cladding to be modified locally.

They may therefore be created during the ionic exchanges permitting the core and/or the cladding to be made or during a specific ionic exchange. They may also be obtained by etching the substrate on the zone of interaction or by radiation. In particular, the gratings may be obtained by exposure of the core and/or the cladding to a CO₂ type laser. The laser produces local heating permitting the ions to be re-diffused locally and thus include the pattern of the gratings.

By way of example, the substrate may be swept with a laser beam that is for example amplitude modulated so as to introduce a modulation of the grating at the desired pitch.

1. An artificial cladding grating component for use in integrated optics, comprising:
a substrate;
an optical guide core;
an optical cladding formed in said substrate, said optical cladding being independent of the core and surrounding at least a portion of the core, said optical guide core and said optical cladding having a zone of interaction in said substrate; and
a grating formed in said zone of interaction and constructed and arranged to couple a guided mode of the core to a cladding mode or vice versa;
wherein said zone of interaction is configured to provide coupling variation between the guided mode of the core and the cladding mode along a direction of propagation of the modes; and
wherein a refractive index of the cladding is different from a refractive index of the substrate and lower than a refractive index of the core at least in a part of the cladding next to the core in the interaction zone.

2. The artificial cladding grating component of claim 1, wherein the coupling variation along the direction of propagation of the modes corresponds to a variation of the coupling efficiency and/or the coupling wavelength.

3. The artificial cladding grating component of claim 1, wherein a section of the cladding in the interaction zone is modulated to create the coupling variation.

4. The artificial cladding grating component of claim 1, wherein a centering of the core with respect to the section of the cladding is modulated to create the coupling variation.

5. The artificial cladding grating component of claim 3, wherein a modulation of the section of the cladding is uniform.

6. The artificial cladding grating component of claim 3, wherein a modulation of the centering of the core with respect to the section of the cladding is uniform.

7. The artificial cladding grating component of claim 3, wherein a modulation of the section of the cladding is a discrete variation.

8. The artificial cladding grating component of claim 4, wherein a modulation of the centering of the core with respect to the section of the cladding is a discrete variation.

9. A method of manufacturing an artificial cladding grating component comprising:
providing a substrate; and
modifying a refractive index of said substrate to form an optical guide core, a cladding and a grating in said substrate, said optical guide core and said optical cladding having a zone of interaction in said substrate, and said grating being formed in said zone of interaction and constructed and arranged to couple a guided mode of the core to a cladding mode or vice versa,
wherein said zone of interaction is configured to provide coupling variation between the guided mode of the core and the cladding mode along the direction of propagation of the modes, and
wherein a refractive index of the cladding is different from a refractive index of the substrate and lower than a refractive index of the core at least in a part of the cladding next to the core in the interaction zone.

10. The method of claim 9, wherein said modifying includes irradiating said substrate and/or exposing said substrate to ionic species.

11. The method of claim 9, wherein said modifying includes:
a) exposing the substrate to a first ionic species,
b) exposing the substrate to a second ionic species,
c) burying said first and second ionic species to form the cladding and the guide core, and
d) forming said grating.

12. The method of claim 11, wherein the first and/or second ionic species are introduced by ionic exchange or by ionic implantation.

13. The method of claim 11, wherein the substrate includes glass and contains Na⁺ ions, and the first and the second ionic species includes Ag⁺ and/or K⁺ ions.

14. The method of claim 11, further comprising:
defining a first mask on said substrate prior to exposing the substrate to a first ionic species, the first mask comprising a pattern configured to define the cladding, and the first ionic species being introduced via said first mask:
removing said first mask; and
defining a second mask on said substrate after removing said first mask and prior to exposing the substrate to said second ionic species, said second mask comprising a pattern configured to define the core, and the second ionic species being introduced via this second mask.

15. The method of claim 11, wherein said grating is formed during exposure of said substrate to ionic species with a mask defining the core and/or the cladding, or formed with a specific mask.

16. The method of claim 11, wherein the grating is obtained by local heating.

17. The method of claim 11, wherein the grating is obtained by etching the substrate next to the interaction zone.

18. The method of claim 11, wherein the burying comprises applying an electrical field to said substrate.

19. The method of claim 11, wherein the burying comprises re-diffusing the first and second ionic species in an ionic bath.

20. The method of claim 11, wherein all or part of the burying comprises depositing a layer on a surface of the substrate.

21. The method of claim 9, wherein the first ionic species and/or the second ionic species are introduced with the application of an electrical field.
